(19) United States
(12) Patent Application Publication
(10) Pub. No.: US 2016/0052752 A1
(43) Pub. Date: Feb. 25, 2016

(54) MARINE CONNECTOR

(71) Applicant: BALLTEC LIMITED, LancashirE (GB)

(72) Inventor: Owen Walmsley, Highland (GB)

(73) Assignee: Balltec Limited, Lancashire (GB)

(21) Appl. No.: 14/779,259

(22) PCT Filed: Feb. 21, 2014
(86) PCT No.: PCT/GB2014/050542

§ 371 Date: Sep. 22, 2015

(30) Foreign Application Priority Data
Feb. 22, 2013 (GB) 1303199.2

(51) Int. Cl. B66C 1/66; B63B 21/20

(52) U.S. Cl. CPC B66C 1/66; B63B 21/20; B63B 2021/007

(57) ABSTRACT

A marine connector having a central core, a first shoulder disposed around at least part of the central core, a second shoulder disposed around at least part of the central core and spaced from the first shoulder and an expandable clamping member disposed around at least part of the central core and between the first and second shoulders. The first and second shoulders are relatively movable from a first distance apart, wherein the clamping member is at a first or rest width, to a second distance apart, wherein the shoulders act upon the clamping member to expand it outwardly from the central core to a second or expanded width. In use the connector may be received into a complementary female receptacle or into a length of pipe, to act as a pipeline recovery tool.

### FIELD OF THE INVENTION

The present invention relates to marine connectors, especially those used in pipeline recovery systems and in mooring connectors.

### BACKGROUND TO THE INVENTION

Marine connectors come in a variety of forms. Two such fowls are mooring connectors and pipeline recovery system connectors.

Mooring lines are used in a variety of applications. One such application would be the mooring of an off-shore oil drilling platform. A remotely operated underwater vehicle (“ROV”) would typically be used to install such connectors and such connectors would typically rely upon a ball and taper mechanism. These mechanisms and the connectors associated with them will typically be large, expensive and require special tooling to connect and disconnect.

During pipe-laying operations a pipe-laying vessel will feed out lengths of pipe in order to connect, for example, an off-shore drilling platform with storage or processing units, either off-shore or on-shore. Pipe-laying vessels commonly, but unintentionally, lose the pipe. Further, they may have to discontinue pipe-laying due to severe weather and drop the pipe onto the seabed. Since the pipe will generally be laid upon the seabed, a recovery operation will be required to recover the pipe and continue the pipe-laying. Given the depth of water usually encountered in such laying operations, an ROV will be used to connect a pipeline recovery tool to the pipe. Such tools are typically in the form of an elongate circular cross-section body with an outer diameter co-operable with the internal diameter of the pipe to be recovered. The body is inserted into the free end of the pipe and usually a ball and taper mechanism is used to grip the pipe internally. Again, these mechanisms may be large, expensive and require special tooling to connect and disconnect.

### SUMMARY OF THE INVENTION

According to the present invention there is provided a connector comprising a central core, a first shoulder disposed around at least part of the central core, a second shoulder disposed around at least part of the central core and spaced from the first shoulder, an expandable clamping member disposed around at least part of the central core and between the first and second shoulders, wherein the first and second shoulders are relatively movable from a first distance apart, wherein the clamping member is at a first or rest width, to a second distance apart, wherein the shoulders act upon the clamping member to expand it outwardly from the core to a second or expanded width.

The width may be a diameter of the clamping member, or some other suitable measure if a non-circular clamping member is used. Both first and second shoulders may both be movable, or one may be fixed and the other movable. The central core may be substantially cylindrical. The first shoulder may be disposed completely around the central core. The second shoulder may be disposed completely around the central core. The clamping member may be disposed completely around the central core. The first and/or second shoulder may be formed as an incline. The incline may be formed as a linear incline. The incline may start from a first point adjacent the central core and slope upwardly and away from the other shoulder. The shoulder may be a hollow conical frustum. The clamping member may be a split collet. The clamping member may comprise six discrete part-circular sections. The sections may be retained by at least one retainer surrounding them. The retainer may be a spring clip. There may be two such spring clips. The at least one spring clip may be seated within a groove provided around the clamping member.

It will be understood that the clamping member may comprise other amounts of discrete sections and still be within the scope of the present invention.

The clamping member may be in the general form or a toroid. The toroid may be a generally triangular cross-section toroid. The apex of the generally triangular cross section may be directed toward the central core. The triangular cross section may have substantially the same angle as the incline of the shoulder. A sliding fit between the two may thereby be formed.

The first shoulder may be movable by a captive bolt. The second shoulder may be movable by a captive bolt. The first and second shoulders may be movable towards one another. The movement towards one another may be caused under action of the same captive bolt.

A compressible bias may be employed to translate the captive bolt's action onto the first or second shoulders.

An outer surface of the clamping member may be adapted to provide better grip. The outer surface may include one or more raised ridges projecting outwardly. The ridges may be provided circumferentially around the clamping member.

The outer surface may also be adapted in further manners to provide better grip; for example, it may be roughened, dimpled, knurled, threaded, etc.

A seal, such as an elastomeric seal, may also be provided around the central core. The first and/or second shoulders may be mounted upon a sleeve.

The seal may be mounted around the sleeve. The seal may act as the compressible bias.

### DETAILED DESCRIPTION OF THE INVENTION

Embodiments of the invention will now be described with reference to the following drawings, in which:

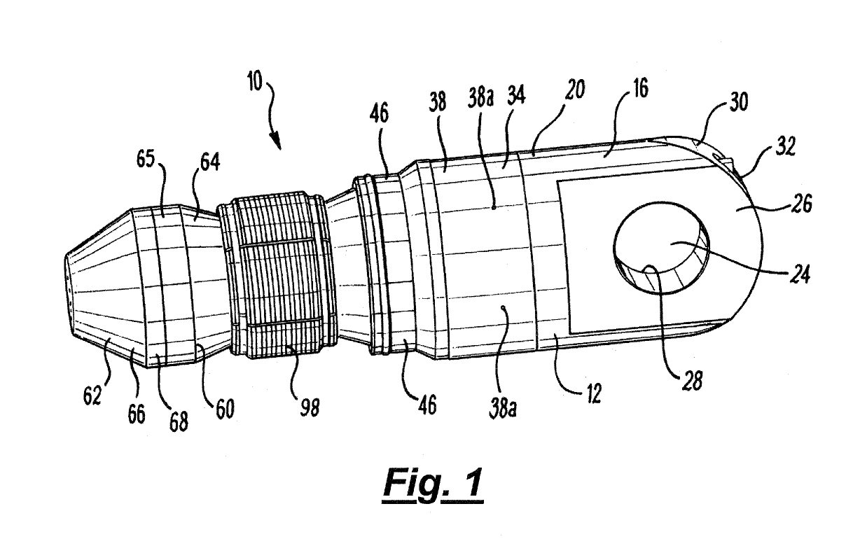

FIG. 1 is a perspective view of a mooring connector according to the present invention in a disengaged position;

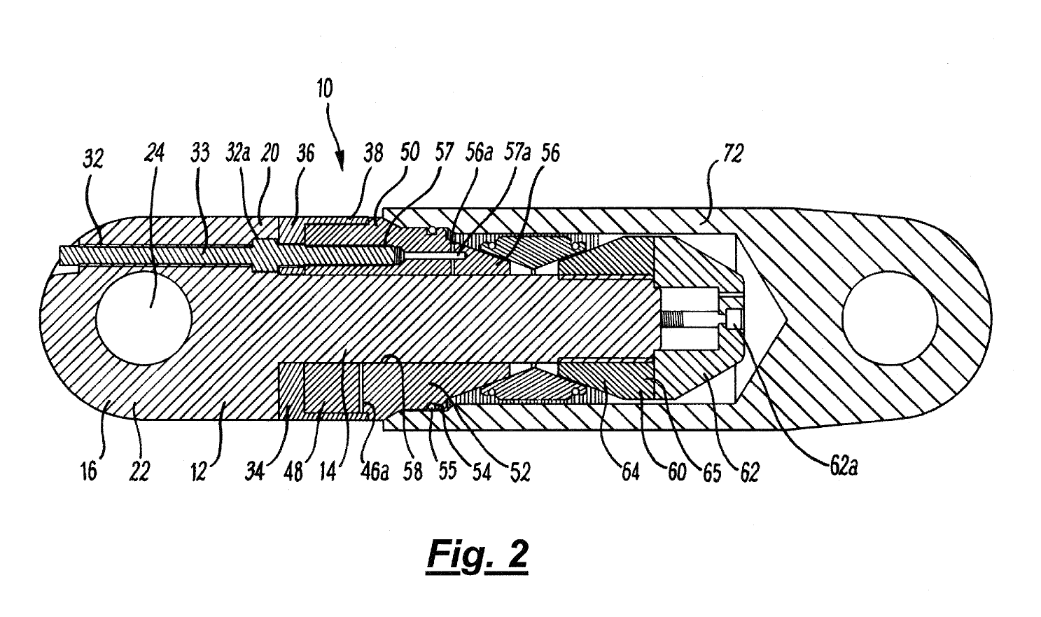

FIG. 2 is a sectional elevation of the mooring connector of FIG. 1 disposed within a corresponding female receptacle in a disengaged position;

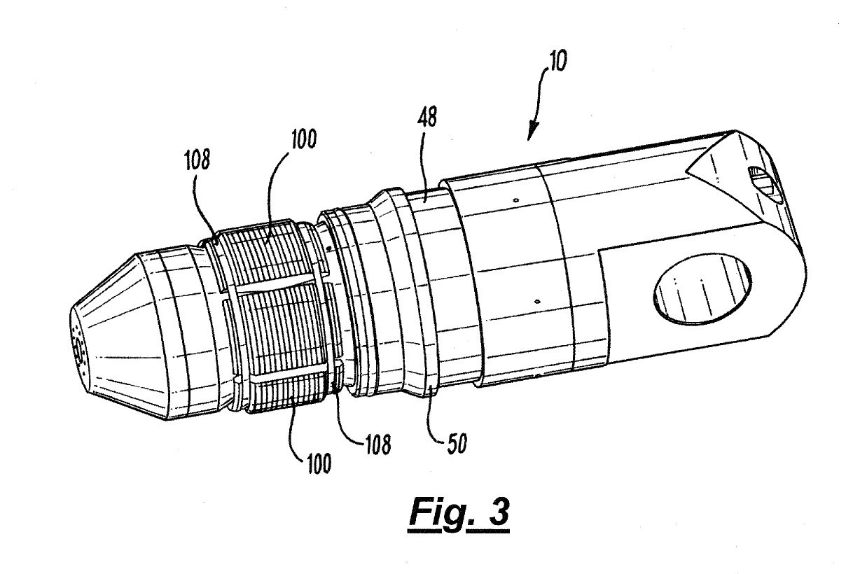

FIG. 3 is a perspective view of the mooring connector of FIG. 1 in an engaged position;

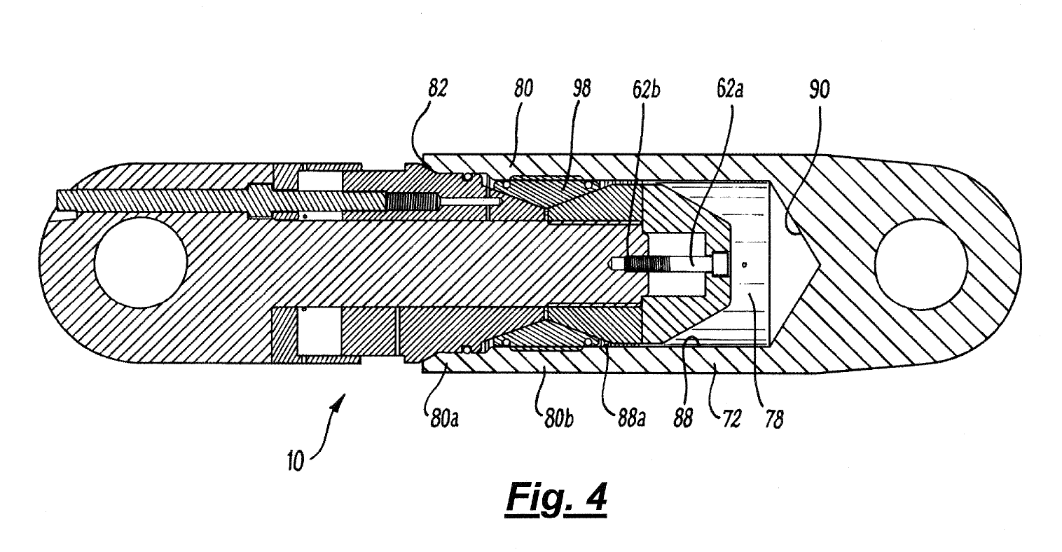

FIG. 4 is a sectional elevation of the mooring connector of FIG. 1 disposed within a corresponding female receptacle in an engaged position;

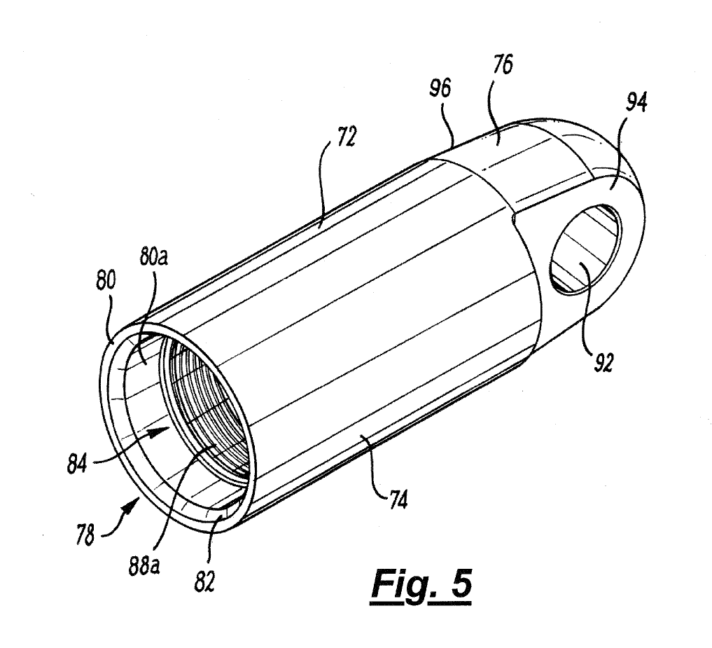

FIG. 5 is a perspective view of a female receptacle shown in FIGS. 2 and 4;

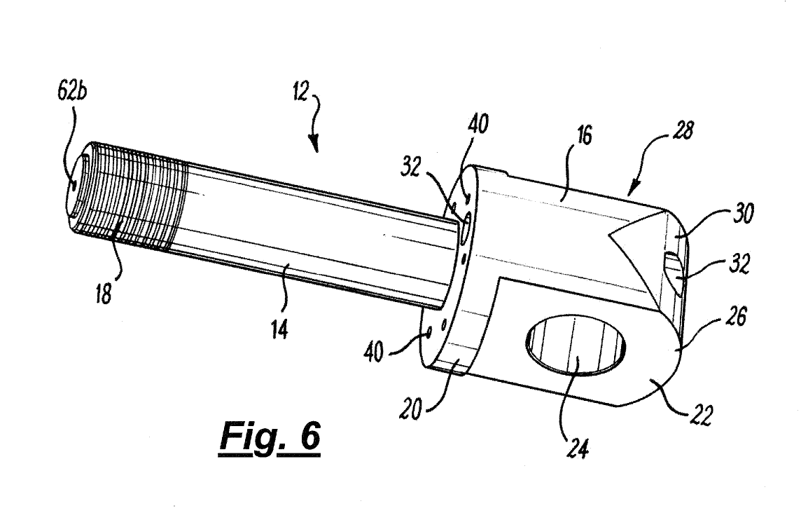

FIG. 6 is a perspective view of the central core of the mooring connector of FIG. 1;

FIG. 7 is a perspective view of a shoulder seat of the mooring connector of FIG. 1;

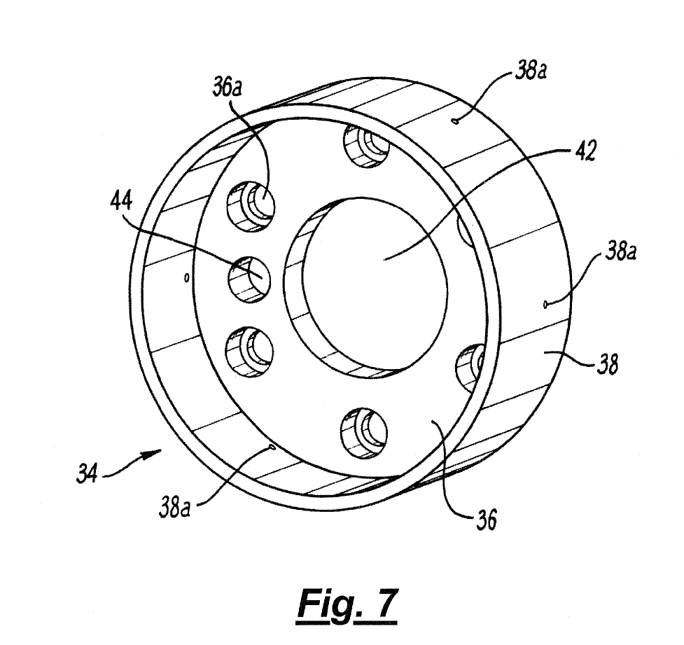

FIG. 8 is a perspective view of a movable shoulder assembly of the mooring connector of FIG. 1;

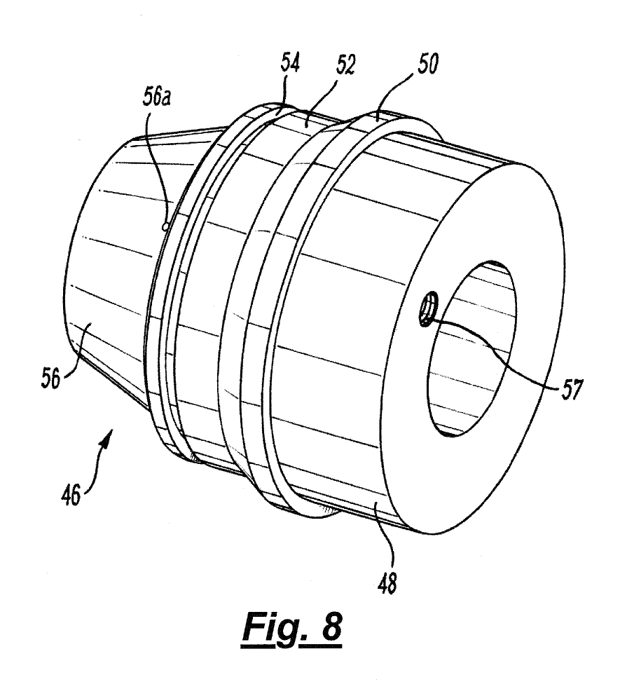

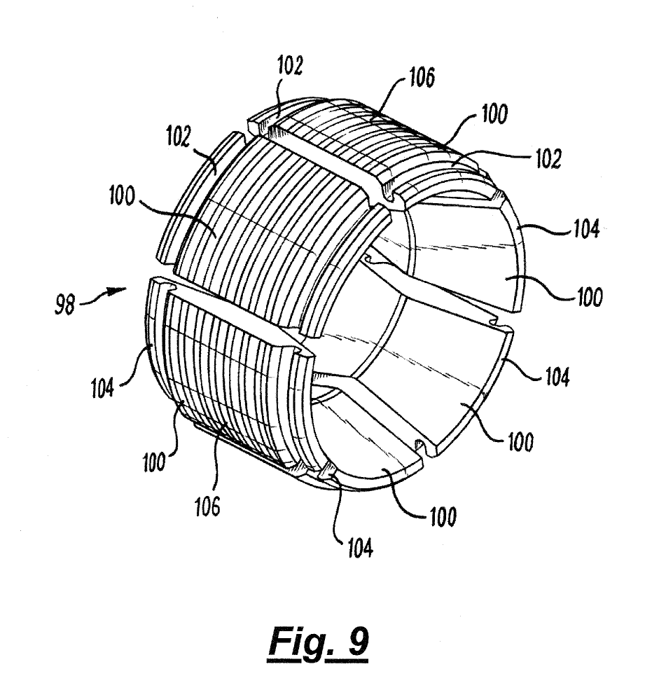

FIG. 9 is a perspective view of a split collet assembly of the mooring connector of FIG. 1;

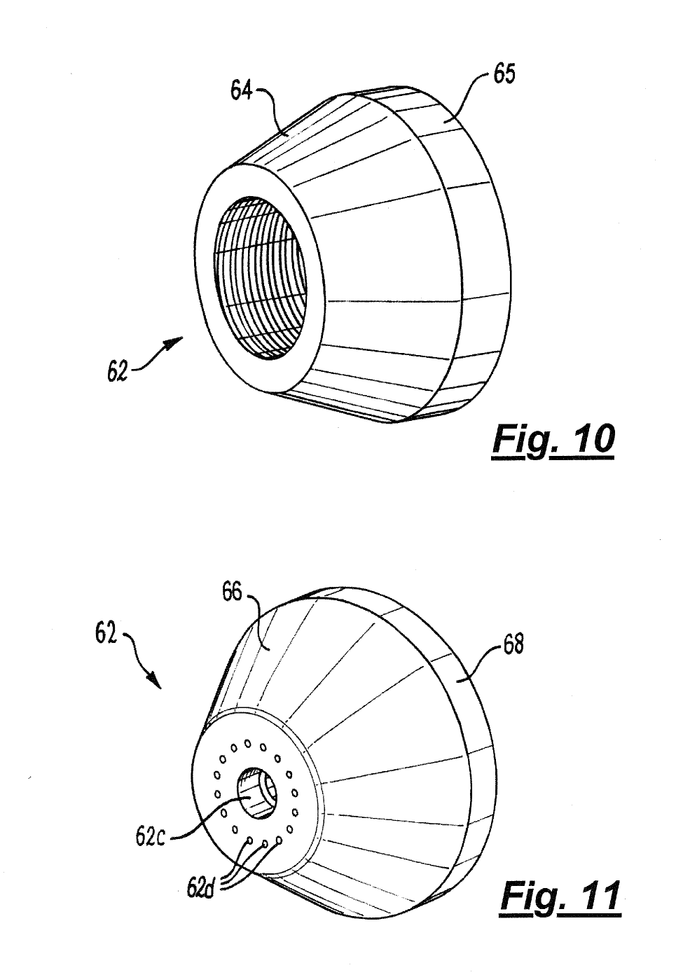

FIG. 10 is a perspective view of a second shoulder of the mooring connector of FIG. 1;

FIG. 11 is a perspective view of a nose cone of the mooring connector of Fig.

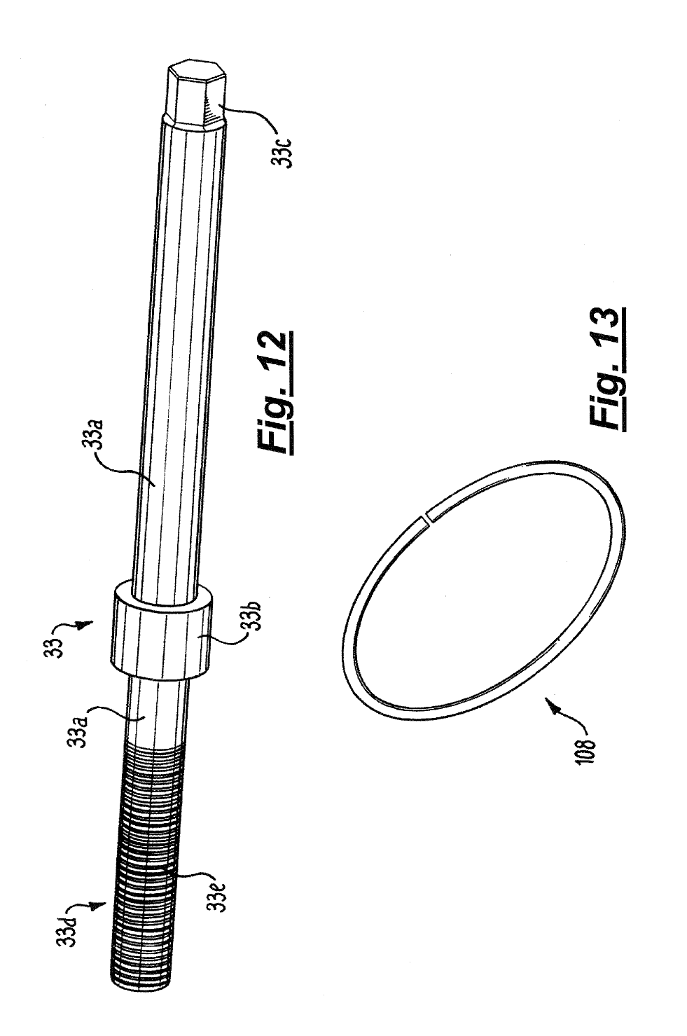

FIG. 12 is a perspective view of the captive bolt of the mooring connector of FIG. 1;

FIG. 13 is a perspective view of a spring clip of the mooring connector of FIG. 1;

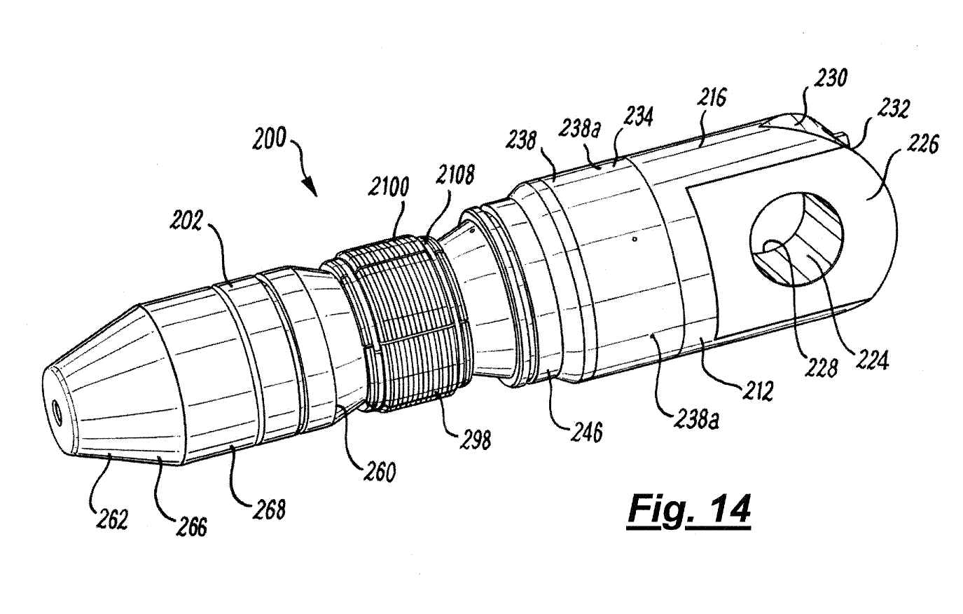

FIG. 14 is a perspective view of a first embodiment pipeline recovery tool according to the present invention;

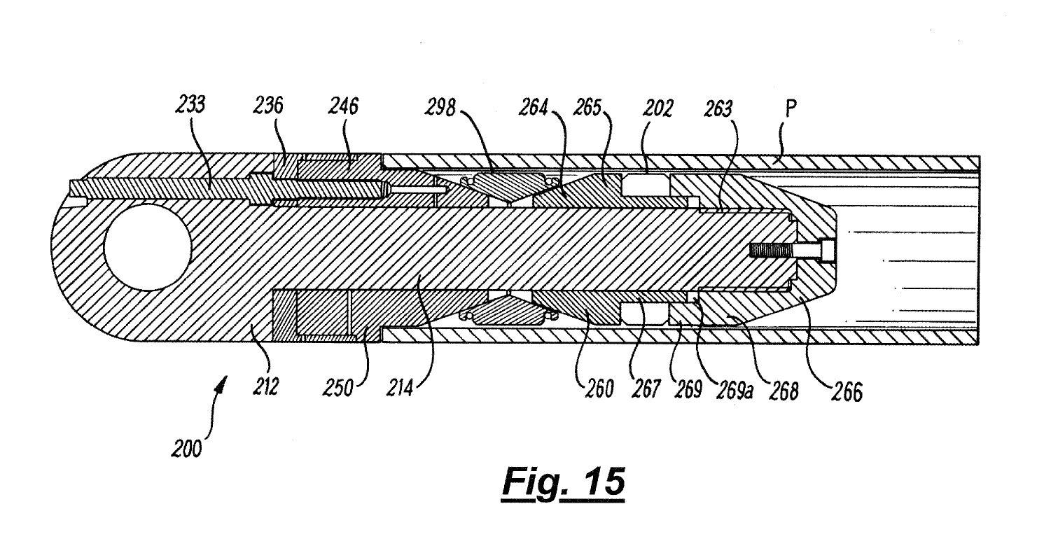

FIG. 15 is a sectional elevation of the pipeline recovery tool of FIG. 14 located within a pipe;

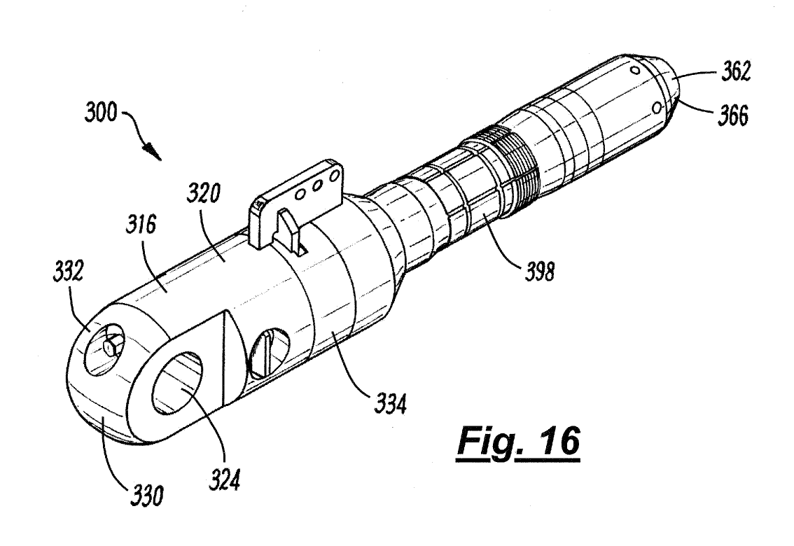

FIG. 16 is a perspective view of a second embodiment pipeline recovery tool according to the present invention;

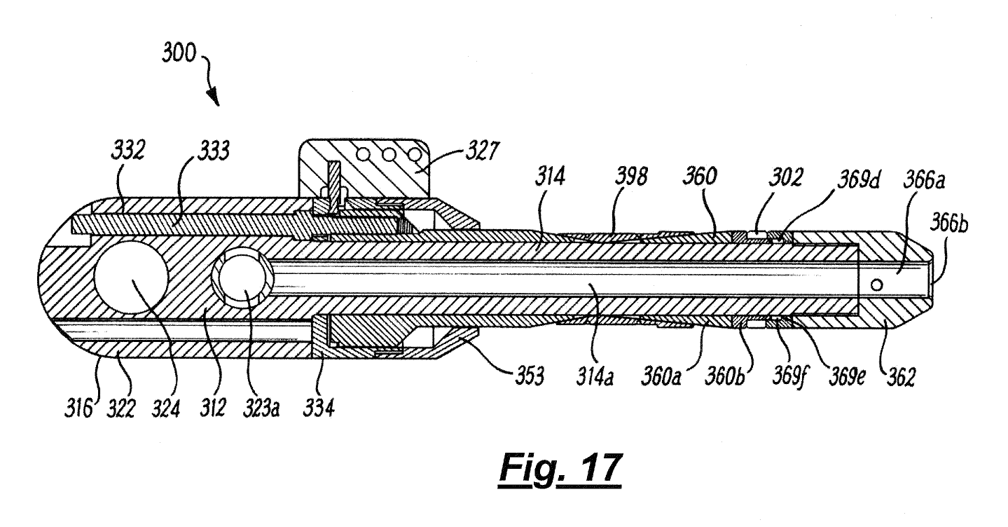

FIG. 17 is a sectional elevation of the pipeline recovery tool of FIG. 16;

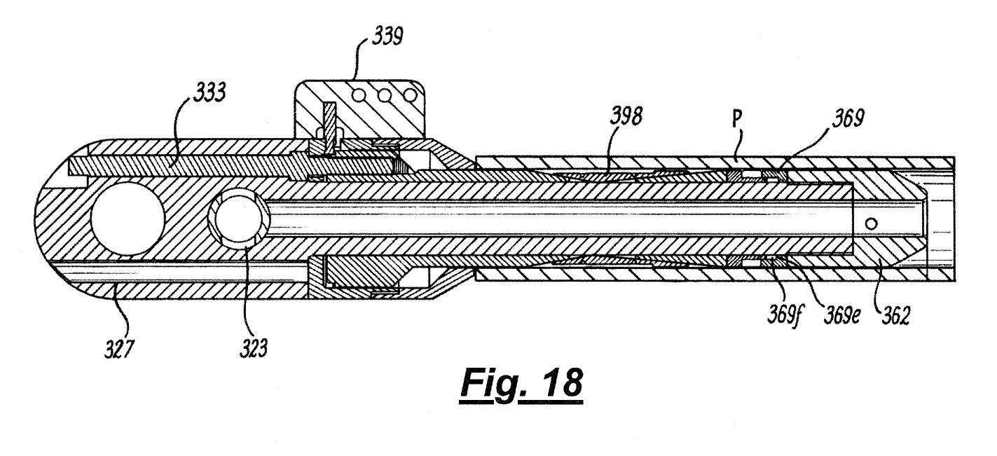

FIG. 18 is a sectional elevation of the pipeline recovery tool of FIG. 16 located within a pipe;

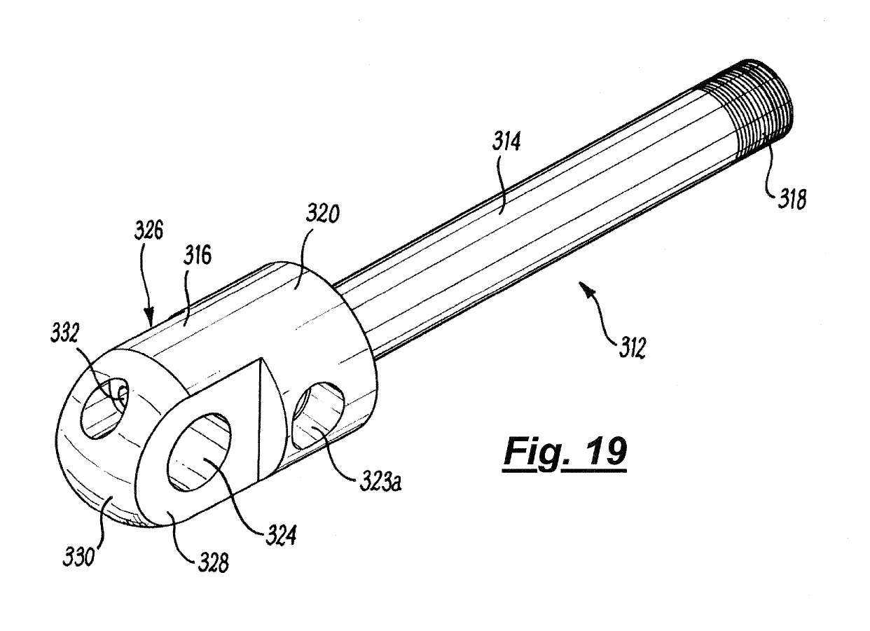

FIG. 19 is a perspective view of a central core of the pipeline recovery tool of FIG. 16;

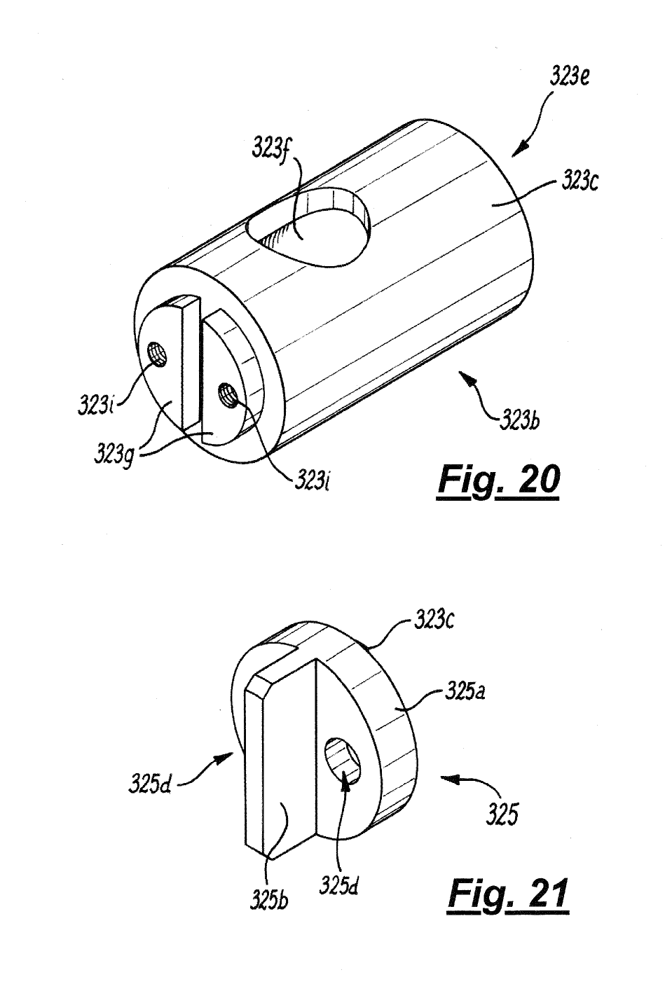

FIG. 20 is a perspective view of a valve body of the pipeline recovery tool of FIG. 16;

FIG. 21 is a perspective view of a valve handle of the pipeline recovery tool of FIG. 16;

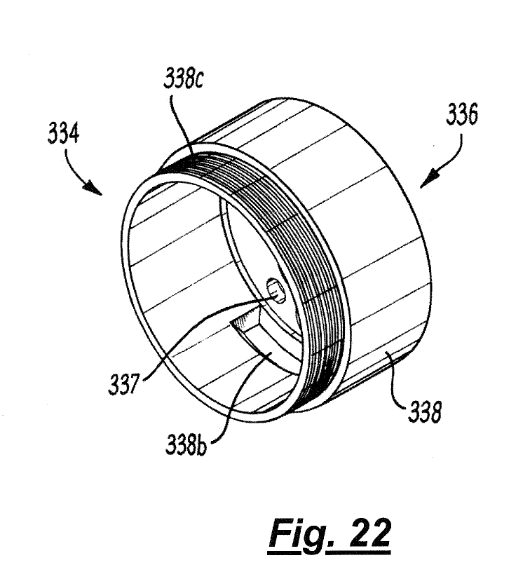

FIG. 22 is a perspective view of a shoulder seat of the pipeline recovery tool of FIG. 16;

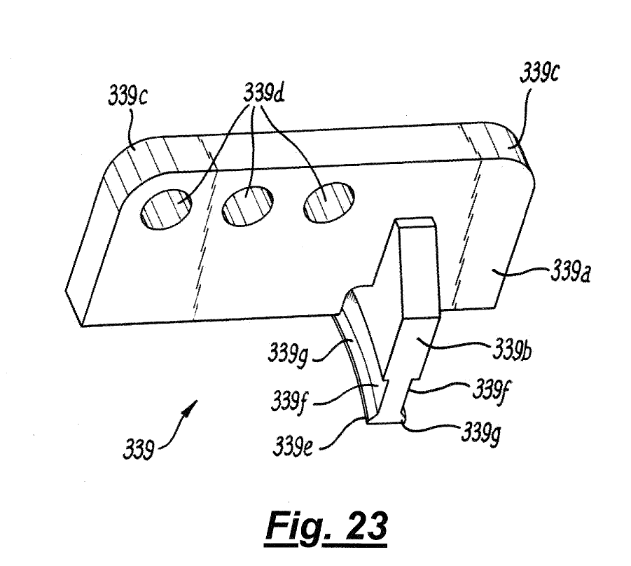

FIG. 23 is a perspective view of a deployment bracket of the pipeline recovery tool of FIG. 16;

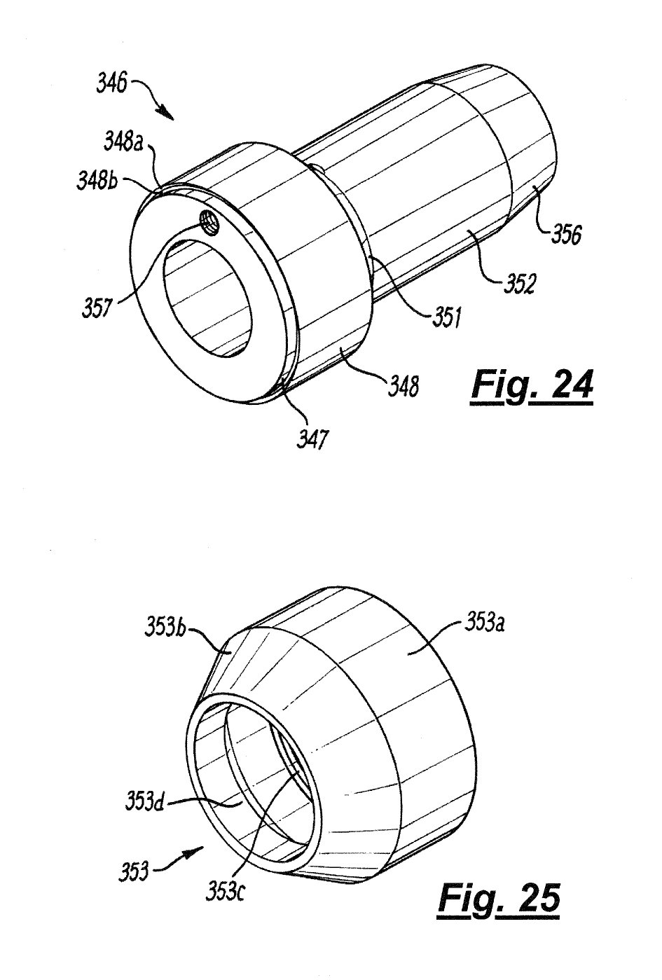

FIG. 24 is a perspective view of a first movable shoulder of the pipeline recovery tool of FIG. 16;

FIG. 25 is a perspective view of an outer retaining collar of the pipeline recovery tool of FIG. 16;

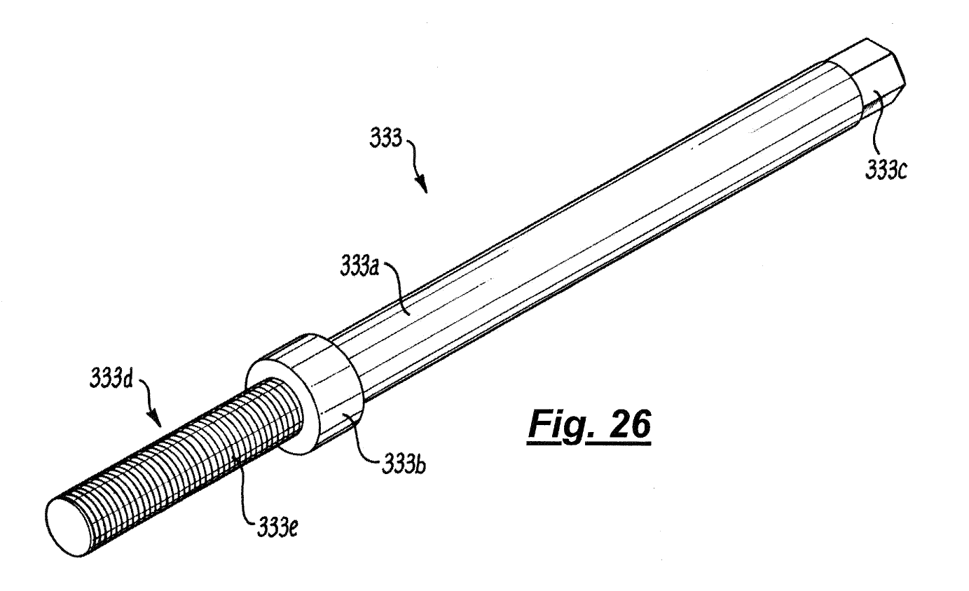

FIG. 26 is a perspective view of a captive bolt of the pipeline recovery tool of FIG. 16;

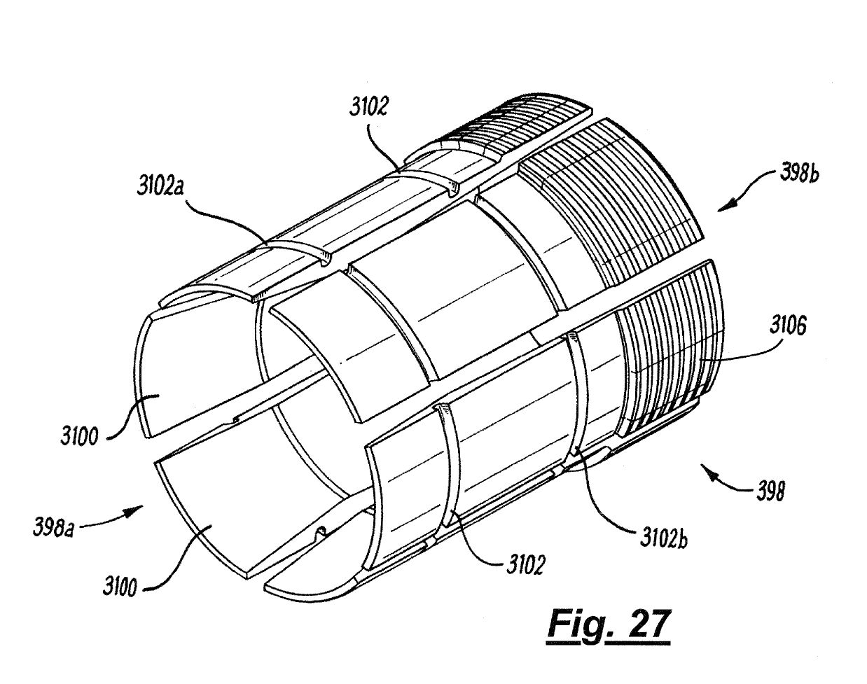

FIG. 27 is a perspective view of a split collet assembly of the pipeline recovery tool of FIG. 16;

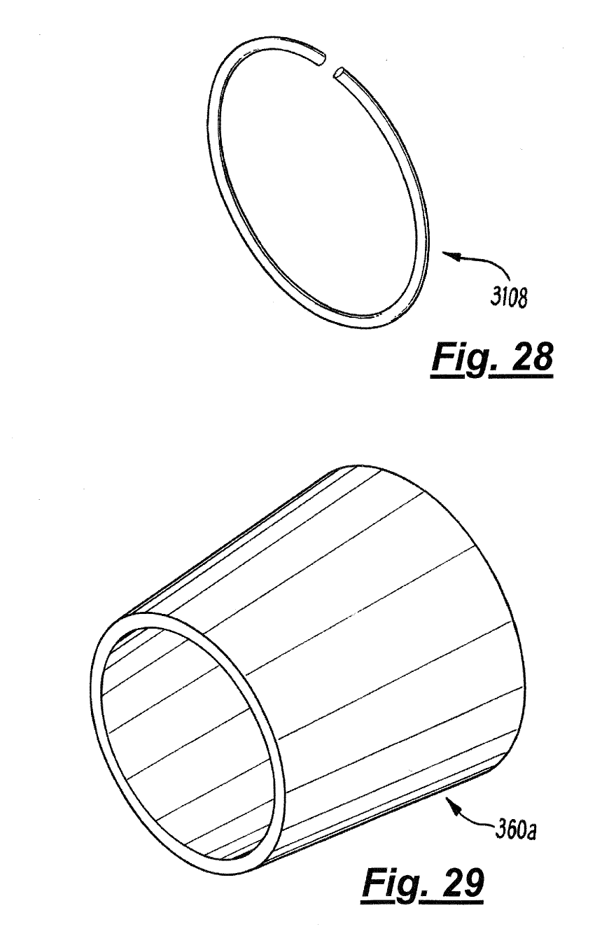

FIG. 28 is a perspective view of a spring clip of the pipeline recovery tool of FIG. 16;

FIG. 29 is a perspective view of a second movable shoulder of the pipeline recovery tool of FIG. 16;

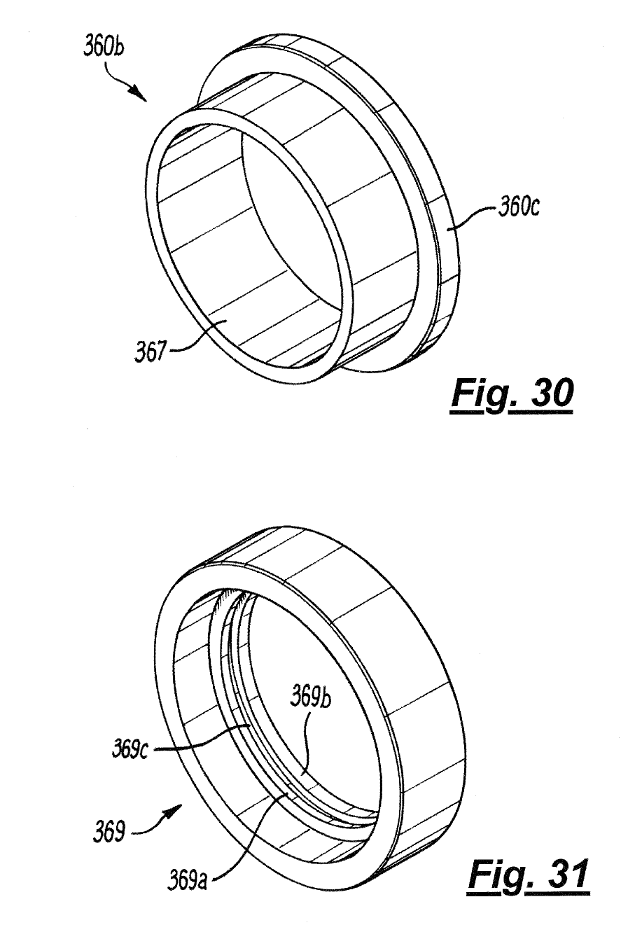

FIG. 30 is a perspective view of a seal retaining ring of the pipeline recovery tool of FIG. 16;

FIG. 31 is a perspective view of an outer seal ring of the pipeline recovery tool of FIG. 16;

FIG. 32 is a perspective view of an elastomeric seal of the pipeline recovery tool of FIG. 16;

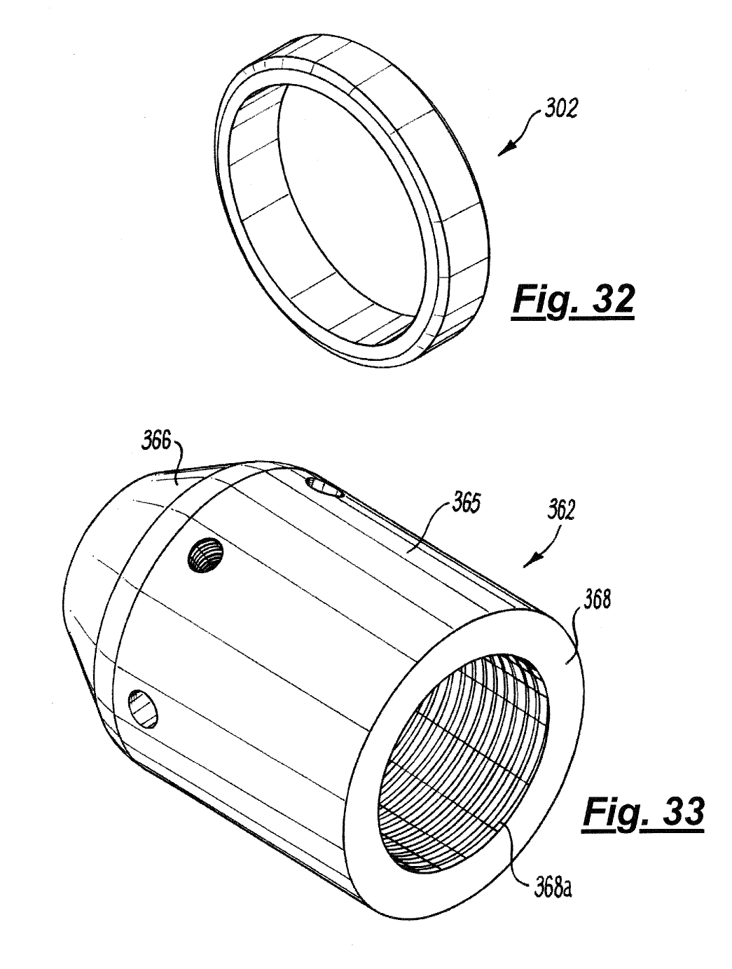

FIG. 33 is a perspective view of a nose cone of the pipeline recovery tool of FIG. 16; and

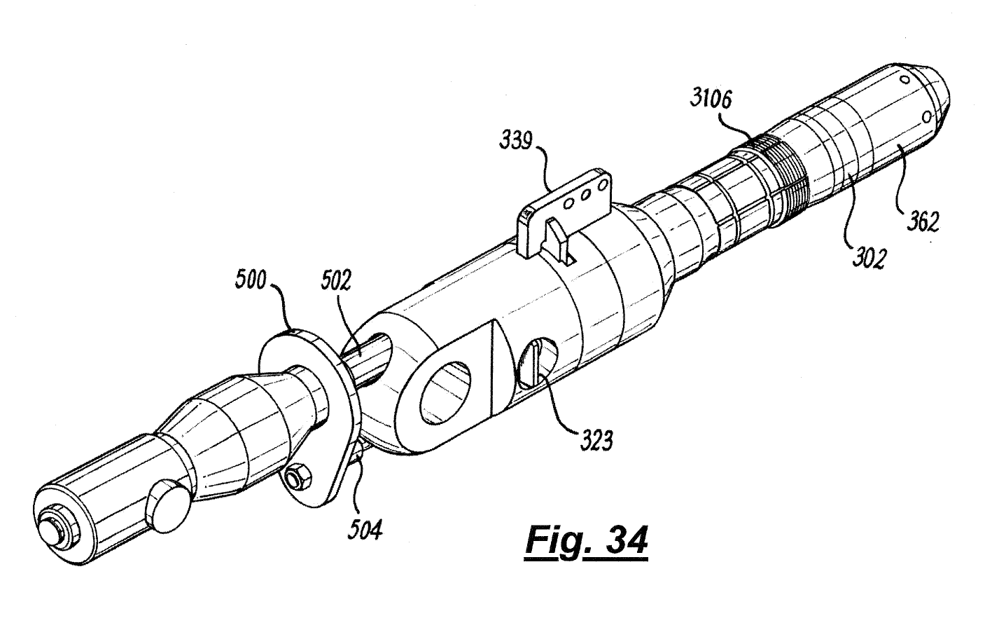

FIG. 34 is a perspective view of the pipeline recovery tool of FIG. 16 with an ROY torque tool engaged.

Referring to the drawings and initially to FIG. 1, a mooring connector 10 is depicted. The mooring connector 10 comprises a body 12. The body 12 comprises a mandrel 14 projecting from a lug 16. The mandrel 14 is generally cylindrical with a threaded portion 18 located at the distal end of the mandrel 14 from the lug 16.

The lug 16 comprises a circular flange portion 20 and a tongue portion 22. The tongue portion 22 has a shackle aperture 24 machined through it, the shackle aperture 24 being disposed with an axis perpendicular to the major axis of the cylindrical mandrel 14. In use, the shackle aperture 24 will receive a suitable shackle (not shown) and line/chain from a mooring point or object to be moored.

The tongue portion 22 is machined from a cylindrical portion, with two planar faces 26, 28 machined perpendicularly to the plane of the circular flange portion 20, with the shackle aperture 24 also located perpendicularly to the planar face 26, 28.

The rearmost portion of the tongue portion 22 is machined to form a rounded face 30, adjacent the planar faces 26, 28, and distally from the circular flange portion 20. A captive bolt bore 32 is formed through the body of the tongue portion 22 extending from the rounded face 30 to the circular flange portion 20. The captive bolt bore 32 extends generally parallel to the major axis of the cylindrical mandrel 14, but offset from the shackle aperture 24.

A shoulder seat 34 attaches to the circular flange portion 20. The shoulder seat 34 comprises a circular flange 36 with a cylindrical outer wall 38 extending from the radial edge of the circular flange 36. The circular flange 36 attaches to the circular flange portion 20 via bolts (not shown) passing through flange apertures 36a on the circular flange 36 and into tapped bores 40 located on the circular flange portion 20. The flange apertures 37 are countersunk such that bolts (not shown) do not project beyond the surface of the circular flange 36. The shoulder seat 34 has a mandrel aperture 42 located at the centre of the circular flange 36 to allow the shoulder seat 34 to pass over the mandrel 14. A captive bolt aperture 44 is also formed in the circular flange 36. A plurality of vent bores 38a are formed through the cylindrical outer wall 38 which allow fluid (liquid or gas) from the surrounding environment to fill and drain from the hollow interior of the shoulder seat 34 defined within the cylindrical outer wall 38.

A movable shoulder 46 locates around the mandrel 14 adjacent and initially within the shoulder seat 34. The movable shoulder 46 comprises a generally cylindrical spigot portion 48 with a pentagonal toroidal skirt 50 disposed around it. A second cylindrical portion 52 extends from the other side of the skirt 50 and located distally from the skirt 50 extending around the surface of the second cylindrical portion 52 is a seal indentation 54. An elastomeric seal 55 situates within the seal indentation 54.

A frusto-conical shoulder 56 extends from the second cylindrical portion 52.

A mandrel bore 58 extends through the movable shoulder 46 which receives the mandrel 14.

A threaded bore 57 is provided in the spigot portion 48 adjacent and parallel to the mandrel bore 58. The threaded bore 57 extends adjacent to the pentagonal toroidal skirt 50. A narrower blind bore 57a extends from the threaded bore 57 through the second cylindrical portion 52 and partly into the frusto-conical shoulder 56.

A first vent bore 46a is provided through the spigot portion 48, diametrically opposed to the threaded bore 57 and perpendicular to the mandrel bore 58. The first vent bore 46a is in fluid communication with the mandrel bore 58 and the exterior of the spigot portion 48. The first vent bore 46a allows fluid (liquid or gas) from the surrounding environment to fill and drain from the hollow interior of the shoulder seat 34 especially as the spigot portion 48 moves in and out of the shoulder seat 34.

A second vent bore 56a passes through the frusto-conical shoulder 56 perpendicular to the mandrel bore 58. The second vent bore 56a intersects the blind bore 57a. Similarly, the second vent bore 56a and blind bore 57a allow fluid (liquid or gas) from the surrounding environment to fill and drain from the shoulder seat 34. The various vent bores mitigate “vacuum” pressures (i.e. pressures below the surrounding environment) being created which may impede the operation of the apparatus.

A second shoulder 60 and nose cone 62 are attached to the end of the mandrel 14. The second shoulder 60 has a similar profile to the frusto-conical shoulder 56, and comprises a frusto-conical shoulder 64 and short cylindrical section 65. The nose cone 62 also comprises a frusto-conical nose section 66 and short cylindrical section 68. The frusto-conical nose section 66 has a slightly steeper profile than either of the frusto-conical shoulders 56, 64.

The nose cone 62 attaches to the end of the mandrel 14 by a bolt 62a into a threaded bore 62b provided at the end of the mandrel 14 through its centre. A countersunk nose cone bore 62c passes through the centre of the end of the nose cone 62 to allow the attachment of bolt 62a to threaded bore 62b. A plurality of nose cone bores 62d are also provided on the nose cone to allow the insertion of corrosion inhibitor sticks. The bores 62d are offset from the central axis of the nose cone 62 and adjacent the countersunk nose cone bore 62c and are provided in a circular pattern around the countersunk nose cone bore 62c.

A female receptacle 72 is shown in FIG. 5. The receptacle 72 comprises a tubular socket portion 74 with a tongue portion 76. The tubular socket portion 74 has an internal cavity 78 which is generally cylindrical in from. The side wall 80 of the tubular socket portion 74 includes a first fillet 82 at the first open end 84 of the tubular socket portion 74 and a short thinned section 80a of side wall 80 before transitioning through a second fillet 86 to a thicker section 80b of side wall 80. The thinned section 80a is relatively short compared to the thicker section 80b, being about 20% (thinned section 80a) to 80% (thicker section 80b) of the length of the tubular socket portion 74. Approximately 50% of the internal sidewall 88 from adjacent the second fillet 86 is threaded portion 88a. The internal cavity 78 terminates in a conical end section 90. It will be noted that the angle of the first fillet 82 is complementary to the skirt 50.

The tongue portion 76 is similar to the tongue portion 22 of the body 12 comprising a bell-shaped tongue with a shackle aperture 92 extending through it. Similarly, there are two planar faces 94, 96 formed at either side which the shackle aperture 92 is fowled through. In use, the shackle aperture 92 will receive a suitable shackle (not shown) and line/chain from a mooring point or object to be moored.

A captive bolt 33 is shown in FIG. 12. It comprises an elongate body 33a with a central flange 33b approximately half-way along the body 33a. On a first end of the body 33a a hexagonal head 33c is formed. The second end 33d located distally from the first end is a threaded portion 33e.

As can be seen from the Figs., the captive bolt 33 is first fed into the captive bolt bore 32 and the shoulder seat 34 is fed over the mandrel 14 and attached to the circular flange portion 20. The captive bolt bore 32 has an initial larger diameter section portion 32a designed to receive the central flange 33b. The hexagonal head is accessible via the distal end of the captive bolt bore 32 on the tongue portion 22.

The shoulder seat 34 is then fed over the mandrel 14 with the two flanges 20, 36 being bolted together. The captive bolt 33 is therefore trapped within the initial larger diameter section portion 32a of the bore 32, with the second end 33d projecting from the captive bolt aperture 44 of the shoulder seat 34.

The movable shoulder 46 is then fed over the mandrel 14 with the captive bolt 33 attaching to the threaded bore 57 on the spigot portion 48.

The second shoulder 60 and nose cone 62 are then attached as described above.

A split collet 98 is positioned between the movable shoulder 46 and the second shoulder 60. The split collet 98 comprises six collet sections 100 each substantially identical. The split collet 98 forms a generally triangular toroid shape, with the apex of the triangular cross-section being directed towards the centre of the collet 98. The angle of the triangular shape is complementary to that of the two shoulders 46, 60. Two spring clip indentations 102 are formed around the outer circumference of the collet 98, one at either end. Two outer lips 104 faun the outer boundaries of the spring clip indentations 102. The outer surface 106 of the split collet is ridged (or could be threaded in the alternative) for increased grip as will subsequently be described. Two spring clips 108 are seated within the spring clip indentations 102 and retain the collet sections 100 as a split collet 98.

In the initial position (FIGS. 1 & 2), the cylindrical spigot portion 48 of the movable shoulder 46 is located within the shoulder seat 34. In this position, the movable shoulder 46 and second shoulder 60 are at their greatest distance apart. This may be considered a first distance apart. The split collet 98 abuts both at either end and since the two shoulders 46, 60 are at their greatest distance apart, the split collet 98 is at an initial or rest diameter, which is the minimum diameter of the collet 98. As can be seen from the Figs, each collet section 100 abuts its immediate neighbours along its longitudinal edge 100a. It will be appreciated by the skilled addressee that the collet sections 100 need not abut each other in the initial or rest diameter. The pentagonal toroidal skirt 50 abuts the first fillet 82.

Rotating the captive bolt 33 causes the movable shoulder 46 to move along the mandrel 14 towards the second shoulder 60. In fact, the mandrel 14 is drawn out of the female receptacle 72 by the action of the captive bolt 33. This draws the second shoulder 60 towards the movable shoulder 46. The split collet 98 is compressed longitudinally against the two shoulders 46, 60 which urge it outwardly from the mandrel 14 (FIGS. 3 & 4). The effective diameter of the collet 98 expands towards a second or expanded width.

As can be seen from FIG. 4, when the mooring connector 10 is located within a female receptacle 72 and the collet is expanded by the mechanism described above, the outer surface 106 of the collet 9R abuts and engages the threaded portion 88a of the side wall 80 of the female receptacle 72 creating an interference fit between the mooring connector 10 and the female receptacle 72, thus the collet 98 acts as a clamping member, to clamp the mooring connector 10 to the female receptacle 72.

Turning to FIGS. 14 & 15, a second embodiment of the present invention is depicted. The second embodiment is a pipeline recovery tool 200. The pipeline recovery tool 200 shares a degree of similarity with the mooring connector 10, and similar or identical parts will use a similar numbering system as used to describe the first embodiment mooring connector 10 except prefixed with a “2”. For example, the central mandrel of the pipeline recovery tool 200 is denoted 214, and a collet section is denoted 2100.

The main difference is that the second shoulder 260 is not fixed relative to the mandrel 214 as in the mooring connector 10, but may move along the mandrel 214.

The second shoulder seal 260 comprises a frusto-conical shoulder 264, short cylindrical section 265 and a shoulder sleeve 267. The shoulder sleeve 267 is disposed around the mandrel 214 and located distally from the first movable shoulder 246.

A second shoulder seal 202 is disposed between the nose cone 262 and the second shoulder 260; the second shoulder seal locating around the shoulder sleeve 267. The nose cone 262 comprises a frusto-conical nose section 266 and short cylindrical section 268. A cylindrical outer wall 269 projects from the short cylindrical section 268. A recess 269a is thereby formed between the mandrel 214 and the cylindrical outer wall 269 which receives the shoulder sleeve 267. The nose cone 262 attaches to the threaded portion 218 of the mandrel 214 by way of a threaded bore 263.

The skirt 250 on the movable shoulder 246 is not a pentagonal toroid, but a simple flange.

The pipeline recovery tool 200 is inserted into a pipe P (see FIG. 15). Skirt 250 abuts the open end of pipe P, which will have a planar form and thus the skirt 250 may abut the end without a significant gap.

Captive bolt 233 is then engaged and rotated causing the mandrel 214 to be drawn out of the pipe P. The second shoulder 260 is drawn towards the movable shoulder 246. This acts upon the split collet 298 which in turn acts upon the second movable shoulder 260 urging the sleeve 267 into the nose cone 262. The shoulder seal 202 is compressed between the short cylindrical section 265 of the second movable shoulder 260 and the short cylindrical section 268 of the nose cone 262.

This compression mechanism expands the shoulder seal 202 radially outwardly into engagement with pipe P. Once no further compression of the shoulder seal 202 is possible, further rotation of the captive bolt 233 forces the second movable shoulder 260 to move towards the first movable shoulder 246 and the sleeve 267 out of the nose cone 262. Movement of the second shoulder 260 may be characterized as a passive or reactive movement i.e. one which does not require its own captive bolt or other mechanism to cause movement along the mandrel 214.

The split collet 298 is then compressed between the two inwardly moving shoulders 246, 260 and expands radially outwardly into engagement with the pipe P. The outer “teeth” of the split collet 298 will tend to “bite” into engagement with the inner surface of the pipe P. Pipe P may then be manipulated with the apparatus. Any load to pull the tool 200 out of the pipe causes greater engagement between the collet 298 and pipe P mitigating unintentional disengagement of tool 200 and pipe P.

Once pipe P has been successfully manipulated and engagement of tool 200 no longer required, the captive bolt 233 is simply rotated in the opposite direction to that described above, the above described compression mechanism is reversed, and the collet 298 contracts out of engagement with pipe P and the tool may be removed.

Turning to FIGS. 16-34, a third embodiment of the present invention is depicted. The third embodiment is also a pipeline recovery tool 300. The pipeline recovery tool 300 shares a degree of similarity with the pipeline recovery tool 200 and mooring connector 10, and similar or identical parts will use a similar numbering system as used to describe the first embodiment mooring connector 10 and the pipeline recovery tool 200 except prefixed with a “3”. For example, the central mandrel of the pipeline recovery tool 300 is denoted 314, and a collet section is denoted 3100.

The pipeline recovery tool 300 comprises a central mandrel 314 about which various components are located. The central mandrel 314 in the present embodiment is hollow and includes a mandrel bore 314a provided along its entire length, the mandrel bore 314a also penetrating into a portion of the lug 316, approximately the depth of the circular flange portion 320.

A valve assembly 323 is provided on the lug 316 adjacent the circular flange portion 320. The valve assembly 323 comprises a valve bore 323a projecting across the lug 316 intersecting and perpendicular to the mandrel bore 314a. The valve bore 323a is largely parallel to the shackle aperture 324.

A PTFE valve body 323b is seated within the valve bore 323a. The valve body 323b comprises a cylindrical body 323c. The cylindrical body 323c is hollow, comprising an outer cylindrical sidewall 323d. The first end 323e of the valve is open, and two valve body bores 323f are provided on the cylindrical sidewall 323d. Mounting lugs 323g project from the second end 323h. The mounting lugs 323g are semi-circular projections and include tapped bores 323i.

A valve handle 325 attaches to the PTFE valve body 323b. The valve handle 325 comprises a circular mounting plate 325a on a first side of which projects a handle plate 325b. The handle plate 325b is used to turn the valve body 323b. A handle lug 325c projects from the second side of the handle plate 325a and is seated between the mounting lugs 323g. Two handle bores 325d are provided through the circular mounting plate 325a and allow bolts (not shown) to attach the valve handle 325 to the valve body 323b via the tapped bores 323i.

A docking bore 327 is formed in the lug 316 and similar to the captive bolt bore 332 extends through the lug 316 from the rounded face 330 to the circular flange portion 320. The docking bore is located on the lug 316 opposite the captive bolt bore 332. The docking bore 327 allows placement of a docking and torque reaction arm 504 from an ROV 500 used to manipulate and attach the pipe recovery tool 300.

Shoulder seat 334 comprises a circular flange 336 with a cylindrical outer wall 338 extending from the radial edge of the circular flange 336. The circular flange 336 =aches to the circular flange portion 320 via bolts (not shown) passing through flange apertures 336a on the circular flange 336 and into tapped bores 340 located on the circular flange portion 320. The flange apertures 337 are countersunk such that bolts (not shown) do not project beyond the surface of the circular flange 336. The shoulder seat 334 has a mandrel aperture 342 located at the centre of the circular flange 36 to allow the shoulder seat 334 to pass over the mandrel 314. A captive bolt aperture 344 is also formed in the circular flange 336. It will be noted that there is no corresponding aperture for the docking bore 327; the shoulder seat seals the end of the docking bore 327. A plurality of vent bores 338a are formed through the cylindrical outer wall 338 which allow fluid (liquid or gas) from the surrounding environment to fill and drain from the hollow interior of the shoulder seat 334 defined within the cylindrical outer wall 338.

A threaded portion 338c is provided at the distal end of the cylindrical outer wall 338. A deployment bracket aperture 338b is provided around a portion of the cylindrical outer wall 338 adjacent the circular flange 336. The deployment bracket aperture 338b is generally a slot-like aperture, being largely rectangular.

The movable shoulder 346 is more elongate than movable shoulders 246 or 46. Movable shoulder 346 comprises an initial, relatively short cylindrical section 347 attached to the first end of the spigot portion 348. A shoulder lip 348a extends from the spigot portion 348 forming a spigot recess 348b around the short cylindrical section 347. The threaded bore 357 that cooperates with the captive bore 333 is located on the short cylindrical section 347. A frusto-conical section 351 extends from the spigot portion 348 with a relatively steep taper angle. A second cylindrical portion 352 extends from the frusto-conical section 351. The length of the second cylindrical portion 352 is approximately 50% of the overall length of the movable shoulder 346. A frusto-conical shoulder 356 extends from the second cylindrical portion 352. The frusto-conical shoulder 356 has a shallower angle than the frusto-conical section 351 being about 5° measured from a central axis of the tool 300. A mandrel bore 358 extends through the movable shoulder 46 which receives the mandrel 314.

An outer retaining collar 353 attaches to the shoulder seat 334. The outer retaining collar 353 comprises a cylindrical section 353a and a frusto-conical section 353b. The cylindrical section 353a has a corresponding threaded portion 353c which is cooperable with the threaded portion 338c of the shoulder seat 334. The outer retaining collar 353 is hollow and a central aperture 353d is provided at the termination of the frusto-conical section 353b. As can be seen from the Figs. the second cylindrical portion 352 of the movable shoulder 346 projects out of the central aperture 353d when the outer retaining collar 353 is attached to the shoulder seat 334. The relatively short cylindrical section 347, the spigot portion 348, the shoulder lip 348a, the spigot recess 348b and the frusto-conical section 351 of the movable shoulder are located within the confines of the outer retaining collar 353 and shoulder seat 334 assembly.

The inner diameter of the outer retaining collar 353 and shoulder seat 334 assembly is only slightly larger than the maximum exterior diameter of the movable shoulder 346, namely the diameter of the spigot portion 348. There is therefore a close fit between the two portions, but a sliding fit of the two relative to one another is provided.

It will also be noted also from the Figs. that the interior surface of the frusto-conical section 353b is substantially the same as that of the frusto-conical section 351 and that the longitudinal space created within the outer retaining collar 353 and shoulder seat 334 assembly is sufficient to enable the movable shoulder 346 to longitudinally traverse the mandrel 314 from a first, or fully retracted position, where the short cylindrical section 347 abuts the shoulder seat 334, to a second, or fully extended position, where the frusto-conical section 351 abuts the interior surface of the frusto-conical section 353b.

A deployment bracket 339 is attached to the outer retaining collar 353 and shoulder seat 334 assembly via the deployment bracket aperture 338b. Deployment bracket 339 comprises an exterior plate 339a, which situates on the exterior surface of the outer retaining collar 353 and shoulder seat 334 assembly, and a deployment bracket lug 339b.

The exterior plate 339a is a generally rectangular plate, with chamfered corners 339c on the edge of the plate 339a located distally from the edge which in use is proximal with the outer retaining collar 353 and shoulder seat 334 assembly. Three deployment bracket apertures 339d for manipulating the deployment bracket 339 and therefore tool 300 are formed through the plate 339a adjacent the edge with the chamfered corners 339c.

The deployment bracket lug 339b is joined and projects from the edge of the plate 339a which in use is proximal with the outer retaining collar 353 and shoulder seat 334 assembly, distally from the chamfered corners 339c and apertures 339d. The distal end 339e of the bracket lug 339b has a curved edge, which matches the curvature of the relatively short cylindrical section 347. Two curved, uniform indentations 339f follow the edge, creating two lips 339g at the curved edge. The upper edges of the bracket lug 339b are filleted.

As can be seen from the Figs, the deployment bracket lug 339b extends into the outer retaining collar 353 and shoulder seat 334 assembly via the deployment bracket aperture 338b. The lips 339g are seated within a chamfer of the deployment bracket aperture on a first side, and within the spigot recess 348b on a second side. When the movable shoulder 346 is in the first, or fully retracted position, an interference fit is formed which retains the deployment bracket lug 339b to the tool 300.

The split collet 398 comprises six collet sections 3100 each substantially identical. The split collet 398 foams a generally triangular toroid shape, with the apex of the triangular cross-section being directed towards the centre of the collet 398.

The triangular profile in the present embodiment is irregular rather than generally isosceles. Two spring clip indentations 3102 are formed around the outer circumference of the collet 398, the first 3102a formed approximately 20% of the length from a first end 398a of the collet 398 and the second 3102b approximately 60% of the length from the first end 398a or 40% from a second end 398b of the collet 398. Two spring clips 3108 are seated within the spring clip indentations 3102 and retain the collet sections 3100 as a split collet 398.

The ridged outer surface portion 3106 is offset towards the second end 398b of the collet 398 i.e. at a distal end of the collet 398 away from the movable shoulder 346 and towards the nose cone 362.

Second movable shoulder 360 comprises two separate parts: a frusto-conical shoulder section 360a and a seal retaining ring sleeve 360b. The frusto-conical shoulder section 360a is a conical frustum with a taper angle being about 5° measured from a central axis of the tool 300. The seal retaining ring sleeve 360b comprises a cylindrical flange 360c having an outer diameter substantially equal to that of the greatest diameter of the conical frustum, and a sleeve portion 367 having an outer diameter substantially equal to that of the smallest diameter of the conical frustum.

The cylindrical flange 360c is placed adjacent the greatest diameter of the conical frustum of the frusto-conical shoulder section 360a. An elastomeric seal 302 is placed over the sleeve portion 367.

An outer seal ring 369 is placed over the mandrel adjacent the elastomeric seal 302 and sleeve portion 367. The outer seal ring 369 is generally a rectangular toroid with two inner flanges 369a, 369b at the distal side from the elastomeric seal 302 and sleeve portion 367. An O-ring/PTFE seal 369e is placed in a recess 369c disposed between the two inner flanges 369a, 369b. The inner diameter of the outer sleeve ring 369 is sufficient to enable it to pass over the sleeve portion 367. The inner diameter of the inner flanges 369a, 369b are complementary to the outer diameter of the mandrel 314 thus ensuring proper placement. A recess 369d is foamed between the sleeve portion 367 and inner flange 369a. An O-ring/PTFE seal 369f is placed within the recess 369d.

The nose cone 362 also comprises a frusto-conical nose section 366 and cylindrical section 368. The frusto-conical nose section 366 has a steeper profile than either of the frusto-conical shoulders 356, 364. The cylindrical section 368 is hollow and has an inner threading 368a that is complementary with the threaded portion 318 of the mandrel 314. The frusto-conical nose section 366 is also hollow with an inner bore 366a and aperture 366b. Thus, when the tool 300 is inserted into the pipe P a fluid path is formed from the interior of pipe P through the mandrel bore 314a and on to the valve assembly 323. Nose cone 362 also functions as a PIG-catcher assembly.

In use, the tool 300 is lowered near to the end of pipe P using a line (not shown) attached to the deployment bracket 339. A shackle (not shown) on the end of this line (not shown) is connected to the most appropriate aperture 339d as judged by the user. An ROV 500 guides the tool 300 into the pipe P. A torque tool 502 on the ROV 500 engages with the captive bolt 333 and a torque reaction arm 504 is seated within the docking bore 327. The torque tool 502 rotates the captive bolt 333.

Rotation of the captive bolt 333 causes the first movable shoulder 346 to traverse the mandrel 314 away from the shoulder seat 334. Again, the mandrel 314 is effectively being withdrawn from the pipe P. This causes the disengagement of the interference fit that retains the deployment bracket 339, thereby releasing the line.

The frusto-conical shoulder 356 acts upon the split collet 398 which in turn acts upon the second movable shoulder 360 pushing the sleeve 367 into the outer seal ring 369. The shoulder seal 302 is therefore compressed.

This compression mechanism expands the shoulder seal 302 radially outwardly into engagement with pipe P. Once no further compression of the shoulder seal 302 is possible, further rotation of the captive bolt 333 forces the second movable shoulder 360 to move towards the first movable shoulder 346 and the sleeve 367 out of the outer seal ring 369. Movement of the second shoulder 360 may be characterized as a passive or reactive movement i.e. one which does not require its own captive bolt or other mechanism to cause movement along the mandrel 314.

The split collet 398 is then compressed between the two relatively inwardly moving shoulders 346, 360 and expands radially outwardly into engagement with the pipe P. Pipe P may then be manipulated with the apparatus. The outer “teeth” of the split collet 398 will tend to “bite” into engagement with the inner surface of the pipe P. Pipe P may then be manipulated with the apparatus. Any load to pull the tool 300 out of the pipe causes greater engagement between the collet 398 and pipe P mitigating unintentional disengagement of tool 300 and pipe P. Seal 302 provides a watertight seal against pipe P.

The valve assembly 327 may then be moved to its open position and the pipe P may be dewatered. This is normally accomplished by pumping a dewatering PIG into the pipe P. The nose cone 362 is adapted to receive the PIG and allow the dewatering operation to take place. The nose cone 362 prevents the PIG from moving back along the pipe P.

The ROV 500 will shut the valve assembly 327 once dewatering is complete, and the tool 300 may then be used to manipulate pipe P.

Once pipe P has been successfully manipulated and engagement of tool 300 no longer required, the captive bolt 333 is simply rotated in the opposite direction to that described above, the above described compression mechanism is reversed, and the collet 398 contracts out of engagement with pipe P and the tool may be removed.

Modifications and improvements may be undertaken to the above described embodiments without departing from the scope of the present invention.

For example, although a shoulder angle of 5° is mentioned for the third embodiment, this angle may be varied to any suitable degree. A range of 3° to 10° may be preferable.

1. A marine connector comprising:
a central core;
a first shoulder disposed around at least part of the central core;
a second shoulder disposed around at least part of the central core and spaced from the first shoulder; and
an expandable clamping member disposed around at least part of the central core and between the first and second shoulders;
wherein the first and second shoulders are relatively movable from a first distance apart, wherein the clamping member is at a first or rest width, to a second distance apart, wherein the shoulders act upon the clamping member to expand it outwardly from the central core to a second or expanded width.

2. A marine connector as claimed in claim 1, wherein both the first and second shoulders are movable.

3. A marine connector as claimed in claim 1, wherein one of the first and second shoulders is movable, and the other of the first and second shoulders is fixed in position around the central core.

4. A marine connector as claimed in claim 1, wherein the central core is cylindrical.

5. A marine connector as claimed in claim 1, wherein the first shoulder is disposed around the central core so as to entirely surround it.

6. A marine connector as claimed in claim 1, wherein the second shoulder is disposed around the central core so as to entirely surround it.

7. A marine connector as claimed in claim 1, wherein the clamping member is disposed around the central core so as to entirely surround it.

8. A marine connector as claimed in claim 1, wherein the first and/or second shoulder presents a surface which is inclined relative to the major axis of the central core.

9. A marine connector as claimed in claim 8, wherein the incline is a linear incline.

10. A marine connector as claimed in claim 8, wherein the incline of one shoulder extends from a first point adjacent the central core and slopes away from both the major axis of the central core and the other shoulder.

11. A marine connector as claimed in claim 1, wherein one or bother shoulders comprises a hollow conical frustum.

12. A marine connector as claimed in claim 1, wherein the clamping member is a split collet.

13. A marine connector as claimed in claim 12, wherein the split collet comprises six discrete part-circular sections.

14. A marine connector as claimed in claim 13, wherein the part-circular sections are retained by at least one retainer surrounding them.

15. A marine connector as claimed in claim 14, wherein the retainer is a spring clip.

16. A marine connector as claimed in claim 14, wherein the at least one retainer is seated within a groove provided around each part-circular section.

17. A marine connector as claimed in claim 13, wherein the part-circular sections collectively form a toroidal shape.

18. A marine connector as claimed in claim 13, wherein the part-circular sections are generally triangular in cross-section.

19. A marine connector as claimed in claim 18, wherein the apex of the generally triangular cross section is directed toward the central core.

20. A marine connector as claimed in claim 19, wherein the inclined surfaces of the triangular cross section are generally complementary to the incline of the first and/or second shoulder.

21. A marine connector as claimed in claim 1, wherein the relative movement of the first and second shoulders is effected by means of a captive bolt.

22. A marine connector as claimed in claim 1, wherein the outer surface of the clamping member comprises one or more outwardly projecting ridges.
